(19) United States
(12) Patent Application Publication
(10) Pub. No.: US 2024/0380078 A1
(43) Pub. Date: Nov. 14, 2024

(54) COLLECTOR PLATE FOR POWER STORAGE DEVICE, POWER STORAGE DEVICE, AND POWER STORAGE DEVICE PRODUCTION METHOD

(71) Applicant: Panasonic Intellectual Property Management Co., Ltd., Osaka (JP)

(72) Inventors: Toshitaka KOBAYASHI, Osaka Fu (JP); Hiroki HAYASHI, Kyoto Fu (JP)

(73) Assignee: Panasonic Intellectual Property Management Co., Ltd., Osaka (JP)

(21) Appl. No.: 18/692,719

(22) PCT Filed: Sep. 5, 2022
(86) PCT No.: PCT/JP2022/033202

§ 371 Date: Mar. 15, 2024

(30) Foreign Application Priority Data
Sep. 22, 2021 (JP) 2021-154535

(51) Int. Cl. H01M 50/533; B23K 31/02; H01G 11/28; H01G 11/70; H01G 11/84; H01M 10/04; H01M 50/107; H01M 50/179; H01M 50/534; H01M 50/536; H01M 50/566

(52) U.S. Cl. CPC H01M 50/533; B23K 31/02; H01G 11/28; H01G 11/70; H01G 11/84; H01M 10/0431; H01M 50/107; H01M 50/179; H01M 50/534; H01M 50/536; H01M 50/566

(57) ABSTRACT

A current collector plate for a power storage device welded to an end face of a power storage element included in a power storage device. The current collector plate includes a center region, an outer peripheral region, and a bridge portion that connects the center and outer peripheral regions. The outer peripheral region includes a plurality of first weld portions arranged along a radial direction of the end face and welded to the end face. The center region includes a second weld portion that is welded to a conductive member different from the power storage element. A plurality of first through holes in a slit shape are formed to surround the center region such that each of the plurality of first through holes is located between a corresponding one of the plurality of first weld portions and the second weld portion.

### TECHNICAL FIELD

The present disclosure relates to a current collector plate for a power storage device, a power storage device, and a method for producing a power storage device.

### BACKGROUND ART

Conventionally, power storage devices, each including a case, a columnar power storage element that is housed in the case, and a current collector plate that is welded to an end face of the power storage element, are known (for example, Patent Literature 1). A current collector plate of a power storage device disclosed in Patent Literature 1 includes: a plurality of first weld portions that are arranged along a radial direction of the current collector plate and welded to an end face of a power storage element; and a second weld portion that is provided in a center region of the current collector plate and welded to an inner bottom face of a case. In a production process for producing the power storage device, the power storage element and the current collector plate are welded at the first weld portions, and then housed in the case. After that, the case and the current collector plate are welded at the second weld portion.

### CITATION LIST

### Patent Literature

[PTL 1] Laid-Open Patent Publication No. 2006-278013

### SUMMARY OF INVENTION

### Technical Problem

However, with the production process described above, when the second weld portion is welded, due to a distortion that occurs in the current collector plate and heat generated during welding, a harmful effect may occur to the power storage element. Specifically, when a distortion occurs in the current collector plate, the distortion may be transferred to the first weld portions, and the connection between the current collector plate and the power storage element may be degraded. Also, when heat is generated at the second weld portion, the heat may be transferred to the power storage element via the first weld portions, and the characteristics of the power storage element may be degraded. Under the circumstances described above, it is an object of the present disclosure to suppress a degradation in quality of a power storage device.

### Solution to Problem

An aspect of the present disclosure relates to a current collector plate for a power storage device. The current collector plate is a current collector plate for a power storage device that is welded to an end face of a columnar power storage element included in a power storage device, the current collector plate including: a center region; an outer peripheral region; and a bridge portion that connects the center region and the outer peripheral region, wherein the outer peripheral region includes a plurality of first weld portions that are arranged along a radial direction of the end face of the power storage element and welded to the end face of the power storage element, the center region includes a second weld portion that is welded to a conductive member different from the power storage element, and a plurality of first through holes in a slit shape are formed to surround the center region such that each of the plurality of first through holes is located between a corresponding one of the plurality of first weld portions and the second weld portion.

Another aspect of the present disclosure relates to a power storage device. The power storage device includes: a bottomed tubular case that is a conductive member; a power storage element that is housed in the case; and the above-described current collector plate for a power storage device that is housed in the case, wherein the power storage element includes: a first electrode that includes a first current collector in an elongated sheet shape and a first active material layer supported on the first current collector; a second electrode that includes a second current collector in an elongated sheet shape and a second active material layer supported on the second current collector; and a separator interposed between the first electrode and the second electrode, the first electrode, the second electrode, and the separator constitute a columnar wound body, the first current collector is exposed on an end face of the power storage element on a bottom side of the case, the plurality of first weld portions are welded to the first current collector exposed on the end face of the power storage element on the bottom side of the case, and the second weld portion is welded to an inner bottom face of the case.

Another aspect of the present disclosure relates to a power storage device. The power storage device includes: a case that has a first opening; a power storage element that is housed in the case; a sealing member that has a third through hole and seals the first opening; a rivet that is a conductive member that is inserted through the third through hole; and the above-described current collector plate for a power storage device that is housed in the case, wherein the power storage element includes: a first electrode that includes a first current collector in an elongated sheet shape and a first active material layer supported on the first current collector; a second electrode that includes a second current collector in an elongated sheet shape and a second active material layer supported on the second current collector; and a separator interposed between the first electrode and the second electrode, the first electrode, the second electrode, and the separator constitute a columnar wound body, the second current collector is exposed on an end face of the power storage element on the first opening side, the plurality of first weld portions are welded to the second current collector exposed on the end face of the power storage element on the first opening side, and the second weld portion is welded to the rivet.

Another aspect of the present disclosure relates to a method for producing a power storage device. The production method includes the steps of: preparing a bottomed tubular case; preparing a columnar power storage element including: a first electrode that includes a first current collector in an elongated sheet shape and a first active material layer supported on the first current collector, a second electrode that includes a second current collector in an elongated sheet shape and a second active material layer supported on the second current collector; and a separator interposed between the first electrode and the second electrode, wherein the first electrode, the second electrode, and the separator constitute a columnar wound body, and the first current collector is exposed on one end face of the power storage element; and preparing the above-described current collector plate for a power storage device that is welded to the one end face of the power storage element, wherein the method further includes: a first step of welding the plurality of first weld portions of the current collector plate to the first current collector exposed on the one end face of the power storage element; a second step of housing the power storage element and the current collector plate in the case; and a third step of welding the second weld portion of the current collector plate to an inner bottom face of the case.

Another aspect of the present disclosure relates to a method for producing a power storage device. The production method includes the steps of: preparing a columnar power storage element including: a first electrode that includes a first current collector in an elongated sheet shape and a first active material layer supported on the first current collector; a second electrode that includes a second current collector in an elongated sheet shape and a second active material layer supported on the second current collector; and a separator interposed between the first electrode and the second electrode, wherein the first electrode, the second electrode, and the separator constitute a columnar wound body, the power storage element is housed in a case that has a first opening, and the second current collector is exposed on an end face of the power storage element on the first opening side; preparing the above-described current collector plate for a power storage device that is welded to the end face of the power storage element on the first opening side; preparing a sealing member that has a third through hole and seals the first opening; and preparing a rivet that is inserted through the third through hole, wherein the method further includes: a fourth step of welding a proximal end portion of the rivet to the second weld portion of the current collector plate; a fifth step of welding the plurality of first weld portions of the current collector plate to which the rivet has been welded to the second current collector exposed on the end face of the power storage element housed in the case; a sixth step of injecting an electrolyte solution into the case; and a seventh step of sealing the first opening of the case with the sealing member.

### Advantageous Effects of Invention

According to the present disclosure, it is possible to suppress a degradation in quality of a power storage device.

### BRIEF DESCRIPTION OF DRAWINGS

FIG. 1 is an exploded perspective view of a power storage device according to Embodiment 1.

FIG. 2 is a vertical cross-sectional view of the power storage device according to Embodiment 1.

FIG. 3 is a plan view of a current collector plate according to Embodiment 1.

FIG. 4 is a plan view of a current collector plate according to Embodiment 2.

### DESCRIPTION OF EMBODIMENT

A current collector plate for a power storage device, a power storage device, and a method for producing a power storage device according to an embodiment of the present disclosure will be described below by way of examples. However, the present disclosure is not limited to the examples given below. In the following description, specific numerical values and materials may be used as examples. However, other numerical values and materials may also be used as long as the advantageous effects of the present disclosure can be obtained.

### Current Collector Plate for Power Storage Device

A current collector plate for a power storage device according to the present disclosure (hereinafter also referred to simply as “current collector plate”) is welded to an end face of a columnar power storage element included in a power storage device. The current collector plate includes a center region, an outer peripheral region, and a bridge portion that connects the center region and the outer peripheral region. The current collector plate may have a disc shape or any other shape.

The outer peripheral region includes a plurality of first weld portions that are welded to the end face of the power storage element. The plurality of first weld portions are arranged along a radial direction of the end face of the power storage element. The plurality of first weld portions may be arranged equidistantly or non-equidistantly in a circumferential direction of the current collector plate. Each of the plurality of first weld portions may extend in the radial direction of the current collector plate. Each of the plurality of first weld portions may extend to an outermost circumference of the outer peripheral region. The number of first weld portions may be, for example, three or four, but is not limited thereto.

The center region includes a second weld portion that is welded to a conductive member different from the power storage element. The center of the second weld portion may or may not coincide with the center of the center region. It is sufficient that at least one second weld portion is provided. The conductive member may be, for example, a case or a rivet of the power storage device.

A plurality of first through holes in a slit shape are formed to surround the œenter region such that each of the plurality of first through holes is located between a corresponding one of the plurality of first weld portions and the second weld portion. The bridge portion may be provided between two first through holes that are adjacently arranged in the circumferential direction of the current collector plate. One first through hole may be provided for one first weld portion. By forming the plurality of first through holes as described above, each of the plurality of first weld portions is structurally and thermally separated from the second weld portion, excluding a connection path via the bridge portion. Accordingly, when the second weld portion is welded (for example, through ultrasonic welding or laser welding), a distortion that occurs in the second weld portion and heat generated in the second weld portion are unlikely to be transferred to the first weld portions, or in other words, joint portions where the current collector plate and the power storage element are joined. As a result of the first weld portions being unlikely to be distorted, it is possible to suppress a degradation in connection between the current collector plate and the power storage element. Also, as a result of heat being unlikely to be transferred to the first weld portions, the amount of heat transferred into the power storage element is suppressed, and it is therefore possible to suppress a degradation in characteristics of the power storage element.

From the viewpoint of dispersing the distortion of the current collector plate transferred to the first weld portions when the second weld portion is welded as well as dispersing the heat transferred to the power storage element from the second weld portion via the first weld portions so as to enhance the effect of suppressing a degradation in quality of the power storage device, it is desirable that there are three or more bridge portions. In other words, it is desirable that there are at least three first weld portions.

Also, when the internal pressure of the power storage device that includes the current collector plate rises, a large force may be applied to the second weld portion. Even in this case, it is possible to avoid a situation in which a stress caused by the force applied to the second weld portion is locally generated at the first weld portions. Accordingly, it is possible to suppress a degradation in connection between the current collector plate and the power storage element at the first weld portions. This advantageous effect can also be obtained even when a vibration occurs in the power storage device or an impact is applied to the power storage device. Particularly when the current collector plate has a thickness of 500 μm or less (for example, 300 μm or more and 500 μm or less), the stress caused by the force applied to the second weld portion is likely to be locally generated at the first weld portions. Also, the thinner the current collector plate, the more likely a distortion occurs in the current collector plate, and the heat transferred from the second weld portion to the first weld portions is also likely to locally concentrate. For this reason, the above-described configuration is particularly effective when the current collector plate is made using a thin plate with a thickness of 500 μm or less.

Furthermore, the production process for producing the power storage device includes an electrolyte solution injecting step. As a result of the plurality of first through holes being formed at positions very close to the center region of the current collector plate, an electrolyte solution can be efficiently injected via the first through holes, and thus the production process for producing the power storage device can be stabilized.

The first weld portions may have a convex shape that is convex toward the power storage element. The first weld portions may have, for example, a trapezoidal-shaped or arc-shaped cross-section taken along the circumferential direction of the current collector plate. However, the shape of the cross section of the first weld portions is not limited thereto. The first weld portions in a convex shape may be formed through press molding. In this case, because the first through holes are provided between the first weld portions and the second weld portion, and thus the second weld portion is unlikely to be distorted when the first weld portions are formed through press molding, and the flatness of the second weld portion is also maintained at a high level. As a result of the second weld portion having a high level of flatness, particularly when the conductive member and the current collector plate are welded through ultrasonic welding, the welding step can be stabilized.

The current collector plate may be made using a material that contains copper. A bridge portion between adjacent first through holes may have a minimum cross-sectional area of 0.044 mm² or more. The material that contains copper may be, for example, copper or a copper alloy. The term “the minimum cross-sectional area of the bridge portion” refers to the smallest one of the cross-sectional areas of the bridge portions in the circumferential direction of the current collector plate. As a result of the minimum cross-sectional area of the bridge portion being 0.044 mm² or more, when a vibration occurs in the power storage device, for example, it is possible to prevent the bridge portion from being broken due to a tensile stress applied to the bridge portion.

The current collector plate may be made using a material that contains aluminum. A bridge portion between adjacent first through holes may have a minimum cross-sectional area of 0.117 mm² or more. The material that contains aluminum may be, for example, aluminum or an aluminum alloy. As a result of the minimum cross-sectional area of the bridge portion being 0.117 mm² or more, when a vibration occurs in the power storage device, for example, it is possible to prevent the bridge portion from being broken due to a tensile stress applied to the bridge portion.

The current collector plate may satisfy A/B≥0.8, where A represents a width of the bridge portion [mm], and B represents a thickness of the current collector plate [mm]. The term “the width of the bridge portion” refers to a dimension of the bridge portion in the circumferential direction of the current collector plate. If A/B≥0.8 is satisfied, particularly when the first through holes are formed through punching processing, the step of forming the first through holes and the bridge portions can be stabilized.

The first through holes may have a shape that is curved along the circumferential direction of the current collector plate. The shape that is curved along the circumferential direction of the current collector plate may be, for example, an arc shape that extends along the circumferential direction, but is not limited thereto. In the case where the first through holes have such a curved shape, the center region, or in other words, the second weld portion can have a large area, and thus the conductive member and the current collector plate can be easily welded.

The first through holes may have a dimension longer than a dimension of the first weld portions in the circumferential direction of the current collector plate. In this case, two opposing end portions of each first through hole protrude outward relative to a corresponding first weld portion in the circumferential direction of the current collector plate. Due to the protruding portions, the structural and thermal separation of the first weld portion from the second weld portion can be enhanced. Accordingly, the above-described advantageous effects obtained by the separation can be more strongly enhanced.

The first through holes may each include a first portion that extends in the circumferential direction of the current collector plate and second portions that extend along the radial direction of the current collector plate from two opposing ends of the first portion. With this configuration, a region formed between adjacent second portions, or in other words, a bridge portion has an increased dimension in the radial direction of the current collector plate. That is, the structural and thermal separation of the first weld portion from the second weld portion can be even more enhanced. Accordingly, the above-described advantageous effects obtained by the separation can be more strongly enhanced.

The current collector plate may further include a second through hole that is formed between the plurality of first weld portions and different from the plurality of first through holes. As already described, the production process for producing the power storage device includes an electrolyte solution injecting step. As a result of the current collector plate including not only the first through holes but also the second through hole, an electrolyte solution can be efficiently injected via the first through holes and the second through hole, and thus the production process for producing the power storage device can be stabilized.

### Power Storage Device

A power storage device according to one embodiment of the present disclosure (hereinafter also referred to as “power storage device A) includes a bottomed tubular case, a power storage element that is housed in the case, and the above-described current collector plate that is housed in the case.

The case is made using a conductive material, and constitutes a conductive member that is welded to the second weld portion. The case may include a tubular sidewall portion and a bottom portion that closes one end of the sidewall portion. The sidewall portion may have, for example, a cylindrical shape or a prismatic shape. The bottom portion has a shape that conforms to the shape of the sidewall portion.

The power storage element includes a first electrode, a second electrode, and a separator interposed between the first electrode and the second electrode. The first electrode, the second electrode, and the separator constitute a columnar wound body. That is, the first electrode and the second electrode are spirally wound via the separator. The first electrode includes a first current collector in an elongated sheet shape and a first active material layer supported on the first current collector. The second electrode includes a second current collector in an elongated sheet shape and a second active material layer supported on the second current collector.

The first current collector is exposed on an end face of the power storage element on a bottom side of the case. The first active material layer may not necessarily be formed in this exposed portion.

The first weld portions are welded to the first current collector exposed on the end face of the power storage element on the bottom side of the case. The second weld portion is welded to an inner bottom face of the case. With this configuration, an electric connection between the power storage element and the case can be made via the current collector plate. The case functions as an external terminal of the power storage device A. The first weld portions and the first current collector may be welded through, for example, laser welding. The second weld portion and the case may be welded through, for example, ultrasonic welding or laser welding.

A power storage device according to one embodiment of the present disclosure (hereinafter also referred to as “power storage device B”) includes a case that has a first opening, a power storage element that is housed in the case, a sealing member that has a third through hole and seals the first opening, a rivet that is inserted through the third through hole (a conductive member that is welded to the second weld portion), and the above-described current collector plate that is housed in the case.

The first opening of the case may have, for example, a circular shape or a rectangular shape, but the shape of the first opening is not limited thereto. The power storage element may be inserted in the case via the first opening. The case may be curled at a region near the first opening through curling processing. Through the curling processing, the sealing member may be crimped. The case may include, in a region where the sealing member is disposed, a recess portion that is recessed inward in the radial direction. The sealing member may be compressed by the recess portion.

The sealing member may have a shape that conforms to the shape of the first opening. The sealing member may be made using an insulating material (for example, a resin). The third through hole may be provided, for example, at a center of the sealing member. The third through hole may have, for example, a circular shape, but the shape of the third through hole is not limited thereto. The third through hole may extend through the sealing member in a thickness direction of the sealing member.

The power storage element includes a first electrode, a second electrode, and a separator interposed between the first electrode and the second electrode. The first electrode, the second electrode, and the separator constitute a columnar wound body. That is, the first electrode and the second electrode are spirally wound via the separator. The first electrode includes a first current collector in an elongated sheet shape and a first active material layer supported on the first current collector. The second electrode includes a second current collector in an elongated sheet shape and a second active material layer supported on the second current collector.

The second current collector is exposed on an end face of the power storage element on the first opening side. The second active material layer may not necessarily be formed in this exposed portion.

The first weld portions are welded to the second current collector exposed on the end face of the power storage element on the first opening side. The second weld portion is welded to the rivet. With this configuration, an electric connection between the power storage element and the rivet can be made via the current collector plate. The rivet functions as an external terminal of the power storage device B. The first weld portions and the second current collector may be welded through, for example, laser welding. The second weld portion and the rivet may be welded through, for example, ultrasonic welding or laser welding.

### Method for Producing Power Storage Device

A method for producing a power storage device according to one embodiment of the present disclosure (hereinafter also referred to as “production method A”) includes a bottomed tubular case preparing step, a power storage element preparing step, a current collector plate preparing step of preparing the above-described current collector plate, and first to third steps.

The bottomed tubular case may be made using a conductive material (for example, a metal). The case may have, for example, a bottomed cylindrical shape or a bottomed prismatic shape, but the shape of the case is not limited thereto.

In the power storage element preparing step, a columnar power storage element is prepared. The power storage element includes a first electrode, a second electrode, and a separator interposed between the first electrode and the second electrode. The first electrode, the second electrode, and the separator constitute a columnar wound body. The first electrode includes a first current collector in an elongated sheet shape and a first active material layer supported on the first current collector. The second electrode includes a second current collector in an elongated sheet shape and a second active material layer supported on the second current collector. The first current collector is exposed on one end face of the columnar power storage element.

In the current collector plate preparing step, the above-described current collector plate that is welded to the one end face of the power storage element is prepared.

In the first step, the first weld portions of the current collector plate are welded to the first current collector exposed on the one end face of the power storage element. For example, laser welding may be performed in this welding process. Also, this welding process may be performed in a state in which the exposed portion of the first current collector and the first weld portions are pressed against each other.

In the second step, the power storage element and the current collector plate are housed in the case. At this time, the power storage element and the current collector plate may be housed such that the current collector plate is located between the inner bottom face of the case and the power storage element.

In the third step, the second weld portion of the current collector plate is welded to the inner bottom face of the case. For example, ultrasonic welding or laser welding may be performed in this welding process. Also, this welding process may be performed in a state in which an apparatus used for welding (for example, a long horn for ultrasonic welding) is caused to access the vicinity of the inner bottom face of the case via a cavity formed in a center portion of the power storage element.

Another method for producing a power storage device according to one embodiment of the present disclosure (hereinafter also referred to as “production method B”) includes a power storage element preparing step, a current collector plate preparing step of preparing the above-described current collector plate, a sealing member preparing step, a rivet preparing step, and fourth to seventh steps.

In the power storage element preparing step, a columnar power storage element is prepared. The power storage element includes a first electrode, a second electrode, and a separator interposed between the first electrode and the second electrode. The first electrode, the second electrode, and the separator constitute a columnar wound body. The first electrode includes a first current collector in an elongated sheet shape and a first active material layer supported on the first current collector. The second electrode includes a second current collector in an elongated sheet shape and a second active material layer supported on the second current collector. The second current collector is exposed on an end face of the columnar power storage element. The columnar power storage element is housed in a case that has a first opening.

In the current collector plate preparing step, the above-described current collector plate that is welded to the end face of the power storage element is prepared.

In the sealing member preparing step, a sealing member that includes a third through hole and seals the first opening of the case is prepared. The sealing member may be made using an insulating material (for example, a resin). The third through hole may be provided, for example, at a center portion of the sealing member. The third through hole may have, for example, a circular shape, but the shape of the third through hole is not limited thereto.

In the rivet preparing step, a rivet that is inserted through the third through hole is prepared. The rivet may include: a protruding portion that is inserted through the third through hole; and a flange portion that is continuous around a proximal end portion of the protruding portion. The protruding portion may have, for example, a cylindrical shape, but the shape of the protruding portion is not limited thereto. The flange portion may have, for example, a circular shape, but the shape of the flange portion is not limited thereto.

In the fourth step, the proximal end portion of the rivet (for example, the above-described flange portion) is welded to the second weld portion of the current collector plate. For example, ultrasonic welding or laser welding may be performed in this welding process.

In the fifth step, the first weld portions of the current collector plate to which the rivet has been welded are welded to the second current collector exposed on the end face of the power storage element housed in the case. For example, laser welding may be performed in this welding process. Also, this welding process may be performed in a state in which the exposed portion of the second current collector and the first weld portions are pressed against each other.

In the sixth step, an electrolyte solution is injected into the case. Particularly when the current collector plate includes the above-described second through hole, the electrolyte solution can be efficiently injected via both the first through holes and the second through hole. However, the current collector plate does not necessarily need to include the second through hole.

In the seventh step, the first opening of the case is sealed with the sealing member. In this case, a peripheral portion of the sealing member may be crimped by curling a region near the first opening of the case through curling processing. Also, the case may include, in a region where the sealing member is disposed, a recess portion that is recessed inward in the radial direction. The sealing member may be compressed by the recess portion.

A method for producing a power storage device according to one embodiment of the present disclosure includes the first to third steps of the production method A and the fourth to seventh steps of the production method B. Here, the order in which the first to seventh steps are performed is not restricted by the name of the steps or the order in which the first to seventh steps are listed.

As described above, according to the present disclosure, it is possible to suppress a degradation in quality of the power storage device (for example, a degradation in connection between the current collector plate and the power storage element, a degradation in characteristics of the power storage element, and the like). Furthermore, according to the present disclosure, it is possible to provide a high-quality power storage device.

Hereinafter, an example of a current collector plate for a power storage device, a power storage device, and a method for producing a power storage device according to the present disclosure will be described specifically with reference to the drawings. As constituent elements and steps of the current collector plate for a power storage device, the power storage device, and the method for producing a power storage device that will be described below as an example, the above-described constituent elements and steps may be used. The constituent elements and steps of the current collector plate for a power storage device, the power storage device, and the method for producing a power storage device that will be described below as an example can be changed based on the description given above. Also, the description given below may also be applied to the above-described embodiment. Out of the constituent elements and steps of the current collector plate for a power storage device, the power storage device, and the method for producing a power storage device that will be described below as an example, those that are not essential to the current collector plate for a power storage device, the power storage device, and the method for producing a power storage device according to the present disclosure may be omitted. Note that the diagrams used in the following description are schematic representations, and thus they do not accurately reflect the actual shapes or number of the constituent members.

### Embodiment 1

Embodiment 1 of the present disclosure will be described. A power storage device according to the present disclosure encompasses a lithium ion capacitor, an electric double layer capacitor, a lithium ion secondary battery, and the like, and is also suitable as an intermediate power storage device between a lithium ion secondary battery in which a conductive polymer is used in its positive electrode and a lithium ion capacitor. Hereinafter, a power storage device or a lithium ion secondary battery in which a conductive polymer is used in its positive electrode will be described.

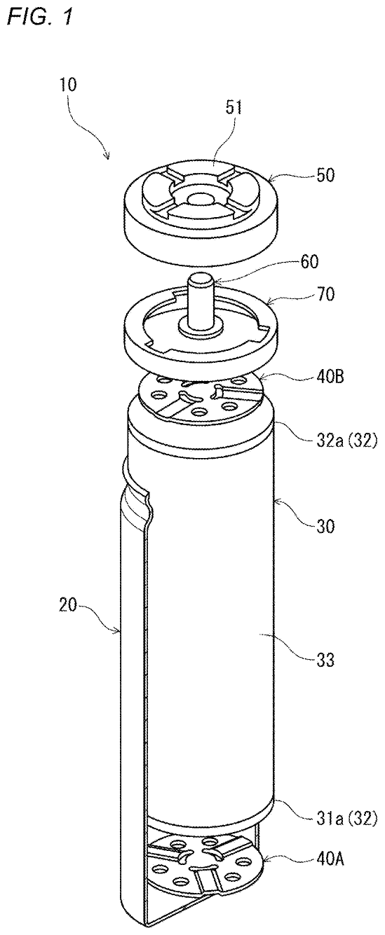

As shown in FIGS. 1 to 3, a power storage device 10 according to the present embodiment includes a case 20, a power storage element 30, two current collector plates 40A and 40B, a sealing member 50, and a rivet 60.

The case 20 is formed in a bottomed cylindrical shape and includes a first opening 21. The case 20 is made using a conductive material (for example, a metal such as aluminum). The case 20 may have, for example, a bottomed cylindrical shape or a bottomed prismatic shape, but the shape of the case 20 is not limited thereto. The case 20 is an example of a conductive member.

The power storage element 30 is housed in the case 20 together with an electrolyte solution (not shown). The power storage element 30 includes a first electrode 31 in an elongated sheet shape, a second electrode 32 in an elongated sheet shape, and a separator 33 interposed between the first electrode 31 and the second electrode 32. The first electrode 31, the second electrode 32, and the separator 33 constitute a columnar wound body.

The first electrode 31 includes a first current collector 31a in an elongated sheet shape and a first active material layer (not shown) supported on the first current collector 31a. The first electrode 31 of the present embodiment constitutes a negative electrode, but is not limited thereto.

As the first current collector 31a, a metal material in a sheet shape is used. The metal material in a sheet shape may be a metal foil, a metal porous body, or the like. As the metal material, it is possible to use copper, a copper alloy, nickel, stainless steel, or the like. The thickness of the first current collector 31a is, for example, 10 μm or more and 100 μm or less.

The first active material layer contains, for example, a negative electrode active material, a conductive agent, and a binder. The first active material layer can be obtained by, for example, applying a negative electrode material mixture slurry containing a negative electrode active material, a conductive agent, and a binder to both surfaces of the first current collector 31a, drying the coating film, and then rolling the coating film. The negative electrode active material is a material that absorbs and desorbs lithium ions. As the negative electrode active material, it is preferable to use a carbon material such as non-graphitizable carbon or graphite. Other examples include a metal compound, an alloy, a ceramic material, and the like.

The second electrode 32 includes a second current collector 32a in an elongated sheet shape, a second active material layer (not shown) supported on the second current collector 32a. The second electrode 32 of the present embodiment constitutes a positive electrode, but is not limited thereto.

As the second current collector 32a, a metal material in a sheet shape is used. The metal material in a sheet shape may be a metal foil, a metal porous body, or the like. As the metal material, it is possible to use aluminum, an aluminum alloy, nickel, titanium, or the like. The thickness of the second current collector 32a is, for example, 10 μm or more and 100 μm or less.

The second active material layer contains, for example, a positive electrode active material, a conductive agent, and a binder. The second active material layer can be obtained by, for example, applying a positive electrode material mixture slurry containing a positive electrode active material, a conductive agent, and a binder to both surfaces of the second current collector 32a, drying the coating film, and then rolling the coating film. The positive electrode active material is a material that absorbs and desorbs lithium ions. Examples of the positive electrode active material include a conductive polymer, a lithium-containing transition metal oxide, a transition metal fluoride, a polyanion, a fluorinated polyanion, a transition metal sulfide, and the like.

As the conductive polymer, it is preferable to use a π-conjugated polymer. As the π-conjugated polymer, it is possible to use, for example, polypyrrole, polythiophene, polyfuran, polyaniline, polythiophene vinylene, polypyridine, or a derivative of π-conjugated polymer. The term “derivative of π-conjugated polymer” refers to a polymer that contains a π-conjugated polymer such as polypyrrole, polythiophene, polyfuran, polyaniline, polythiophene vinylene, or polypyridine as its basic backbone. For example, as a polythiophene derivative, poly(3,4-ethylenedioxythiophene) (PEDOT) or the like may be used. It is preferable to use a π-conjugated conductive polymer. However, conductive polymers are organic substances and have low heat resistance. Accordingly, the conductive polymer is likely to degrade due to heat transferred from the first current collector plate 40A (described later). In contrast, by using a current collector plate that has the above-described characteristic features, heat is more efficiently diffused, and local concentration of heat is suppressed.

As the separator 33, it is possible to use, for example, a microporous film, a woven fabric, a non-woven fabric, or the like that is made of a resin such as polyolefin. The thickness of the separator 33 is, for example, 10 μm or more and 300 μm or less, and preferably 10 μm or more and 40 μm or less.

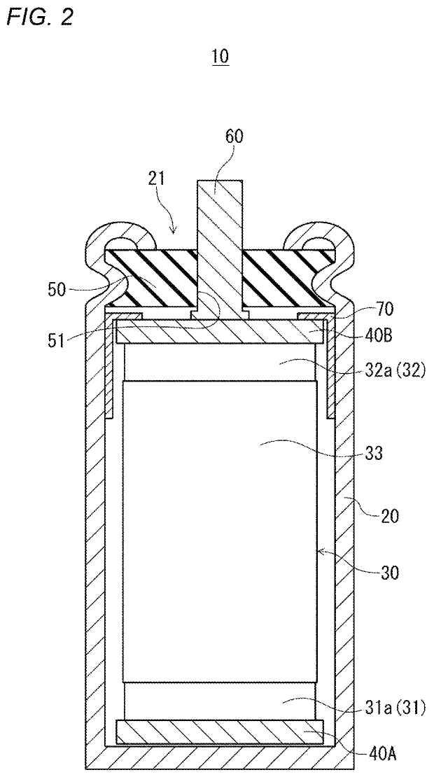

The first current collector 31a is exposed on an end face of the power storage element 30 on the bottom side of the case 20 (on the lower side in FIG. 2). The second current collector 32a is exposed on an end face of the power storage element 30 on the first opening 21 side (on the upper side in FIG. 2).

The two current collector plates 40A and 40B are a first current collector plate 40A provided between the power storage element 30 and a bottom of the case 20 and a second current collector plate 40B provided between the power storage element 30 and the first opening 21. The first current collector plate 40A and the second current collector plate 40B are housed in the case 20.

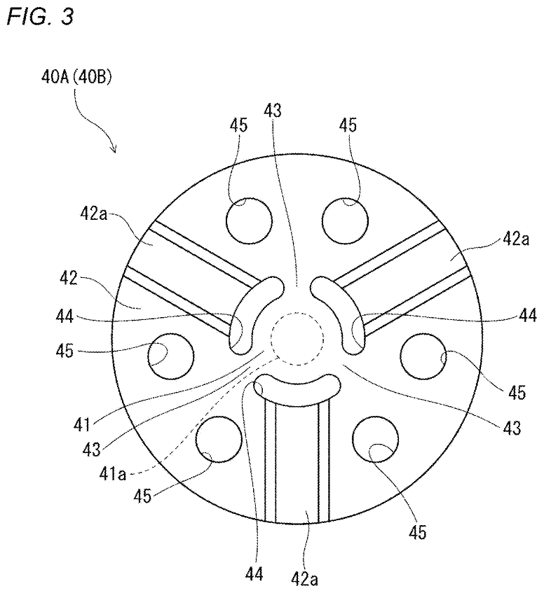

As shown in FIG. 3, the first current collector plate 40A is formed in a circular shape, but the shape of the first current collector plate 40A is not limited thereto. The first current collector plate 40A is made using a material that contains copper (for example, copper or a copper alloy). The material for constituting the first current collector plate 40A may be the same as or different from the material for constituting the first current collector 31a. The first current collector plate 40A includes a center region 41, an outer peripheral region 42, and a bridge portion 43 that connects the center region 41 and the outer peripheral region 42.

The center region 41 is formed in a circular shape, and provided at a center of the first current collector plate 40A. The center region 41 includes a second weld portion 41a that is welded to the case 20. The second weld portion 41a is provided at a center of the center region 41, but the position of the second weld portion 41a is not limited thereto.

The outer peripheral region 42 is formed in a ring shape, and provided so as to surround the center region 41. The outer peripheral region 42 includes a plurality of first weld portions 42a that are welded to an end face of the power storage element 30. The first weld portions 42a are arranged along the radial direction of the end face of the power storage element 30. As shown in FIG. 1, the first weld portions 42a have a convex shape that is convex toward the power storage element 30 (toward the upper side in FIG. 2).

In the present embodiment, three bridge portions 43 are provided, but the number of bridge portions 43 may be two or more, or four or more. However, from the viewpoint of suppressing a deformation such as the center region 41 and the outer peripheral region 42 being twisted relative to each other, the number of bridge portions 43 is preferably three or more. The plurality of bridge portions 43 may be arranged equidistantly or non-equidistantly in the circumferential direction of the first current collector plate 40A.

The minimum cross-sectional area of the bridge portions 43 is 0.044 mm² or more. Here, the cross-sectional area of a bridge portion 43 refers to a cross-sectional area of the bridge portion 43 taken along a section vertical to the radial direction of the first current collector plate 40A. Also, A/B≥0.8 is satisfied, where A represents a width of the bridge portion 43 [mm], and B represents a thickness of the first current collector plate 40A [mm]. As used herein, the width of the bridge portion 43 refers to a dimension of the bridge portion 43 in the circumferential direction of the first current collector plate 40A.

A plurality of first through holes 44 in a slit shape are formed to surround the center region 41 such that each of the plurality of first through holes 44 is located between a corresponding one of the plurality of first weld portions 42a and the second weld portion 41a. The first through holes 44 have a shape that is curved along the circumferential direction of the first current collector plate 40A. The first through holes 44 of the present embodiment extend along the circumferential direction of the first current collector plate 40A as a whole. Two opposing end portions of each first through hole 44 have a round shape. With this configuration, concentration of stress on the end portions of the bridge portion 43 is suppressed, and it is therefore possible to prevent the bridge portion 43 from being broken.

The first through holes 44 have a dimension longer than a dimension of the first weld portions 42a in the circumferential direction of the first current collector plate 40A. Accordingly, two opposing end portions of each first through hole 44 protrude relative to a corresponding first weld portion 42a in the circumferential direction of the first current collector plate 40A. In other words, the bridge portions 43 and the first weld portions 42a are spaced apart from each other in the circumferential direction of the first current collector plate 40A.

The first current collector plate 40A further includes a second through hole 45 that is provided between the plurality of first weld portions 42a and different from the first through holes 44. In this example, six second through holes 45 in a circular shape are provided, but the number of second through holes 45 and the shape of the second through hole 45 are not limited thereto. Also, a plurality of (two in this example) second through holes 45 are formed between any adjacent first weld portions 42a.

The first weld portions 42a of the first current collector plate 40A are welded to the first current collector 31 a exposed on the end face of the power storage element 30 on the bottom side of the case 20. For example, laser welding may be performed in this welding process. The second weld portion 41a of the first current collector plate 40A is welded to the inner bottom face of the case 20. For example, ultrasonic welding may be performed in this welding process.

The second current collector plate 40B is made using a material that contains aluminum (for example, aluminum or an aluminum alloy). The material for constituting the second current collector plate 40B may be the same as or different from the material for constituting the second current collector 32a. The configuration of the second current collector plate 40B is basically the same as the configuration of the first current collector plate 40A. However, in the second current collector plate 40B, the minimum cross-sectional area of the bridge portions 43 is 0.117 mm² or more.

The first weld portions 42a of the second current collector plate 40B are welded to the second current collector 32a exposed on the end face of the power storage element 30 on the first opening 21 side. For example, laser welding may be performed in this welding process. The second weld portion 41a of the second current collector plate 40B is welded to the proximal end portion of the rivet 60. For example, ultrasonic welding may be performed in this welding process. The second current collector plate 40B and the second electrode 32 are covered by an insulation ring 70 at edge portions thereof so as to prevent the second current collector plate 40B and the second electrode 32 from coming into contact with the case 20.

The sealing member 50 seals the first opening 21 of the case 20. The sealing member 50 has a shape that conforms to the shape of the first opening 21. The sealing member 50 of the present embodiment is formed in a disc shape, but the shape of the sealing member 50 is not limited thereto. The sealing member 50 includes a third through hole 51 that is formed at a center portion of the sealing member 50 and extends through the sealing member 50 in the thickness direction (the up down direction in FIG. 2) of the sealing member 50. The sealing member 50 is made using, for example, an elastic body such as butyl rubber.

The rivet 60 is inserted through the third through hole 51 of the sealing member 50. The material for the constituting rivet 60 may be the same as or different from the material for constituting the second current collector plate 40B. The rivet 60 is an example of a conductive member.

### Method for Producing Power Storage Device

Next, a method for producing a power storage device 10 according to the present embodiment will be described. The method for producing a power storage device according to the present embodiment includes the step of preparing the case 20 described above, the step of preparing the power storage element 30 described above, the step of preparing the first and second current collector plates 40A and 40B described above, the step of preparing the sealing member 50 described above, the step of preparing the rivet 60 described above, and first to seventh steps.

In the first step, the first weld portions 42a of the first current collector plate 40A are welded to the first current collector 31a exposed on one end face of the power storage element 30. For example, laser welding may be performed in this welding process.

In the second step, the power storage element 30 and the first current collector plate 40A are housed in the case 20. At this time, the power storage element 30 and the first current collector plate 40A are housed such that the first current collector plate 40A is located between the power storage element 30 and the inner bottom face of the case 20.

In the third step, the second weld portion 41 a of the first current collector plate 40A is welded to the inner bottom face of the case 20. For example, ultrasonic welding may be performed in this welding process.

In the fourth step, the proximal end portion of the rivet 60 and the second weld portion 41 a of the second current collector plate 40B are welded. For example, ultrasonic welding may be performed in this welding process.

In the fifth step, the first weld portions 42a of the second current collector plate 40B to which the rivet 60 has been welded are welded to the second current collector 32a exposed on the other end face of the power storage element 30. For example, laser welding may be performed in this welding process.

In the sixth step, an electrolyte solution is injected into the case 20. The electrolyte solution is injected via the first through holes 44 and the second through holes 45.

In the seventh step, the first opening 21 of the case 20 is sealed with the sealing member 50. At this time, the sealing member 50 is compressed by a portion of the case 20, and a peripheral portion of an exposed surface of the sealing member 50 is crimped by an edge portion of the case 20. Through the steps described above, a power storage device 10 of the present embodiment can be obtained.

### Embodiment 2

Embodiment 2 of the present disclosure will be described. A power storage device 10 according to the present embodiment is different from that of Embodiment 1 described above in that the first through holes 44 have a shape different from the shape described in Embodiment 1. The following description will be given mainly focusing on a difference from Embodiment 1.

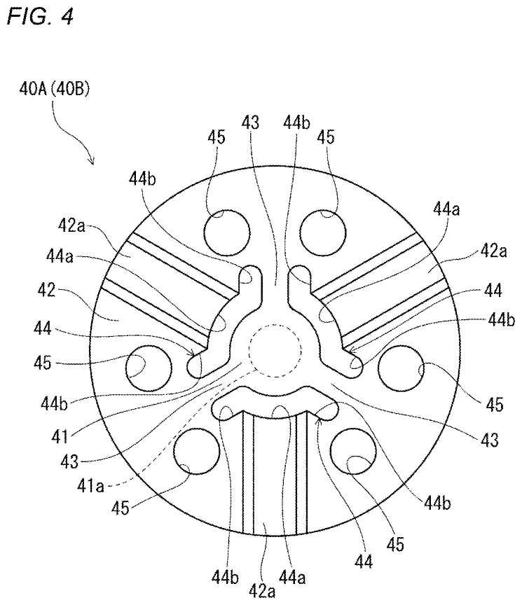

As shown in FIG. 4, each first through hole 44 of a first current collector plate 40A (or a second current collector plate 40B) includes a first portion 44a that extends in the circumferential direction of the first current collector plate 40A and second portions 44b that extend in the radial direction of the first current collector plate 40A from two opposing ends of the first portion 44a. The second portions 44b extend outward in the radial direction of the first current collector plate 40A from the opposing ends of the first portion 44a. The end portions of the second portions 44b have a round shape.

### INDUSTRIAL APPLICABILITY

The present disclosure is applicable to a current collector plate for a power storage device, a power storage device, and a method for producing a power storage device.

### REFERENCE SIGNS LIST

10: power storage device
20: case (conductive member)
21: first opening
30: power storage element
31: first electrode
31a: first current collector
32: second electrode
32a: second current collector
33: separator
40A: first current collector plate (current collector plate)
40B: second current collector plate (current collector plate)
41: center region
41a: second weld portion
42: outer peripheral region
42a: first weld portion
43: bridge portion
44: first through hole
44a: first portion
44b: second portion
45: second through hole
50: sealing member
51: third through hole
60: rivet (conductive member)
70: insulation ring

1. A current collector plate for a power storage device that is welded to an end face of a columnar power storage element included in the power storage device, the current collector plate comprising:
a center region;
an outer peripheral region; and
a bridge portion that connects the center region and the outer peripheral region,
wherein the outer peripheral region includes a plurality of first weld portions that are arranged along a radial direction of the end face of the power storage element and welded to the end face of the power storage element,
the center region includes a second weld portion that is welded to a conductive member different from the power storage element, and
a plurality of first through holes in a slit shape are formed to surround the center region such that each of the plurality of first through holes is located between a corresponding one of the plurality of first weld portions and the second weld portion.

2. The current collector plate for the power storage device in accordance with claim 1,
wherein the plurality of first weld portions have a convex shape that is convex toward the power storage element.

3. The current collector plate for the power storage device in accordance with claim 1,
wherein the current collector plate is made using a material that contains copper, and
the bridge portion between the plurality of first through holes that are adjacently arranged has a minimum cross-sectional area of 0.044 mm² or more.

4. The current collector plate for the power storage device in accordance with claim 1,
wherein the current collector plate is made using a material that contains aluminum, and
the bridge portion between the plurality of first through holes that are adjacently arranged has a minimum cross-sectional area of 0.117 mm² or more.

5. The current collector plate for the power storage device in accordance with claim 3,
wherein the current collector plate satisfies A/B≥0.8, where A represents a width of the bridge portion [mm], and B represents a thickness of the current collector plate [mm].

6. The current collector plate for the power storage device in accordance with claim 1,
wherein the plurality of first through holes have a shape that is curved along a circumferential direction of the current collector plate.

7. The current collector plate for the power storage device in accordance with claim 1,
wherein the plurality of first through holes have a dimension longer than a dimension of the plurality of first weld portions in the circumferential direction of the current collector plate.

8. The current collector plate for the power storage device in accordance with claim 7,
wherein each of the plurality of first through holes includes a first portion that extends in the circumferential direction and second portions that extend along the radial direction of the current collector plate from two opposing ends of the first portion.

9. The current collector plate for the power storage device in accordance with claim 1, further comprising:
a second through hole that is formed between the plurality of first weld portions and different from the plurality of first through holes.

10. A power storage device comprising:
a bottomed tubular case that is a conductive member;
a power storage element that is housed in the case; and
the current collector plate in accordance with claim 1 that is housed in the case,
wherein the power storage element includes:
a first electrode that includes a first current collector in an elongated sheet shape and a first active material layer supported on the first current collector;
a second electrode that includes a second current collector in an elongated sheet shape and a second active material layer supported on the second current collector; and
a separator interposed between the first electrode and the second electrode,
the first electrode, the second electrode, and the separator constitute a columnar wound body,
the first current collector is exposed on an end face of the power storage element on a bottom side of the case,
the plurality of first weld portions are welded to the first current collector exposed on the end face of the power storage element on the bottom side of the case, and
the second weld portion is welded to an inner bottom face of the case.

11. A power storage device comprising:
a case that has a first opening;
a power storage element that is housed in the case;
a sealing member that has a third through hole and seals the first opening;
a rivet that is a conductive member that is inserted through the third through hole; and
the current collector plate in accordance with claim 1 that is housed in the case,
wherein the power storage element includes:
a first electrode that includes a first current collector in an elongated sheet shape and a first active material layer supported on the first current collector;
a second electrode that includes a second current collector in an elongated sheet shape and a second active material layer supported on the second current collector; and
a separator interposed between the first electrode and the second electrode,
the first electrode, the second electrode, and the separator constitute a columnar wound body,
the second current collector is exposed on an end face of the power storage element on the first opening side,
the plurality of first weld portions are welded to the second current collector exposed on the end face of the power storage element on the first opening side, and
the second weld portion is welded to the rivet.

12. A method for producing a power storage device, the method comprising:
preparing a bottomed tubular case;
preparing a columnar power storage element including: a first electrode that includes a first current collector in an elongated sheet shape and a first active material layer supported on the first current collector; a second electrode that includes a second current collector in an elongated sheet shape and a second active material layer supported on the second current collector; and a separator interposed between the first electrode and the second electrode, wherein the first electrode, the second electrode, and the separator constitute a columnar wound body, and the first current collector is exposed on one end face of the power storage element; and
preparing the current collector plate in accordance with claim 1 that is welded to the one end face of the power storage element,
wherein the method further comprises:
welding the plurality of first weld portions of the current collector plate to the first current collector exposed on the one end face of the power storage element;
housing the power storage element and the current collector plate in the case; and
welding the second weld portion of the current collector plate to an inner bottom face of the case.

13. A method for producing a power storage device, the method comprising:
preparing a columnar power storage element including: a first electrode that includes a first current collector in an elongated sheet shape and a first active material layer supported on the first current collector; a second electrode that includes a second current collector in an elongated sheet shape and a second active material layer supported on the second current collector; and a separator interposed between the first electrode and the second electrode, wherein the first electrode, the second electrode, and the separator constitute a columnar wound body, the power storage element is housed in a case that has a first opening, and the second current collector is exposed on an end face of the power storage element on the first opening side;
preparing the current collector plate in accordance with claim 1 that is welded to the end face of the power storage element on the first opening side;
preparing a sealing member that has a third through hole and seals the first opening; and
preparing a rivet that is inserted through the third through hole,
wherein the method further comprises:
welding a proximal end portion of the rivet to the second weld portion of the current collector plate;
welding the plurality of first weld portions of the current collector plate to which the rivet has been welded to the second current collector exposed on the end face of the power storage element housed in the case;
injecting an electrolyte solution into the case; and
sealing the first opening of the case with the sealing member.
